(19) United States
(12) Patent Application Publication
(10) Pub. No.: US 2010/0274657 A1
(43) Pub. Date: Oct. 28, 2010

(54) Integrated Credit Exchange System for Incentivizing Conservation

(76) Inventors: James G. Workman, San Francisco, CA (US); Montgomery F. Simus, Las Vegas, NV (US)

Correspondence Address: CONNIE MASTERS, 2385 Flute Ave, Henderson, NV, 89052, US

(21) Appl. No.: 12/769,637

(22) Filed: Apr. 28, 2010

Related U.S. Application Data
(60) Provisional application No. 61/173,288, filed on Apr. 28, 2009.

(51) Int. Cl. G06Q 30/00; G06Q 50/00; G06Q 10/00

(52) U.S. Cl. 705/14.29

(57) ABSTRACT

A scalable integrated credit exchange system for incentivizing conservation of a resource is provided, which includes a credit allocation system, a consumer interface, and an online trading system. Data is utilized from a measuring system using a smart meter, geospatial monitoring system, and the utility. The incentive is provided in the form of an awarded “ECOSHARE credit” that can be traded in the provided online trading system or can be utilized to reduce the consumer's utility bill.

### CROSS-REFERENCE TO RELATED APPLICATION

This Non-Provisional application claims the benefit of co-pending U.S. Provisional Patent Application No. 61/173,288, filed on Apr. 28, 2009, which is incorporated herein in its entirety.

### FIELD OF THE INVENTION

The present invention relates generally to integrated systems that promote conservation by measuring and monitoring one or more resources used by consumers and by allowing consumers to buy, sell or trade resource credits (“ECOSHARE™ credits”) associated with the resource.

### BACKGROUND INFORMATION

Today, the resources that support all modern economies remain, quite literally, priceless. This irony dates back to 1776, from The Wealth of Nations, when Adam Smith was stumped as to why a “useless” diamond could buy anything else, but “useful” water had no value in exchange. Smith's academic “paradox of value” has real world consequences. Our inability to determine the inherent worth of water (or energy, broadband capacity, etc.) drives people to squander these vital but finite resources. The inevitable result is social inequity, ongoing extinctions and needless suffering from deprivation of basic rights.

As people buy and sell goods and services, they set prices through competitive markets. But developed fresh water and transmitted energy and other resources can be neither owned nor traded in any open and inclusive exchange. Instead of haggling over a price, the government and its regulators rent these vital needs to end users under fixed terms that consumers cannot negotiate, and set rates they must pay. Public pressure artificially lowers value, leading to tragic waste.

Physical laws—one river, one dam, one pipeline, one power line, one fiber optic cable—have long protected the public or private supplier as a “natural monopoly.” The hard infrastructure of physical monopolies remains. Currently, soft, virtual “click” resource trading markets for individuals are not unlocked within the hard “brick and mortar” shells.

Traditionally, critical resource supply providers of water and energy have been considered “natural monopolies,” or at best “duopolies.” As a result, 85% are owned by the public, and 100% have their rates set and fixed by publicly appointed regulatory advocates. This has led to intractable complications throughout the urban water and energy sectors.

As an essential good or service provided by—or at a ceiling set by—public officials, rates have inevitably grown politicized. On the one hand, utilities are rewarded for waste, since the more resources they supply, the greater their revenues. Conversely, profligate consumers enjoy disproportionately low rates since they lack a market partner seeking to negotiate a competitive price for water and energy. The stress of inflexibility imposed on both consumer and provider—whether under a private or public institution—has led to revenue shortfalls, delayed repairs, blackouts, rationing, conflict, waste, externalities, inefficiency and scarcity: a classic tragedy of the commons.

Unlike most other democratic corrective responses, no politician of any party wins election based on a platform to raise water or energy prices across the board. Yet, every crisis reveals an opportunity. A need exists among every municipality for a system to monitor, measure, convert, earn, accumulate, track, save, trade, barter, auction, donate, buy or sell clearly defined efficiency credits in potable water, domestic electricity and computing bandwidth. In the case where a political platform is absent, a novel system can step in to benefit provider and consumer alike.

Supplies of energy, water and other resources around the world are under pressure, with the pressure increased by human-induced global warming. In the United States, even the most upbeat optimists concede we now face an unprecedented water crisis. Today, utilities and other urban institutions are being forced to analyze, adapt and reorient to meet the demands for these resources.

One course of action taken by the utilities is to deploy remote, automated metering instrumentation, known as “smart meters,” to replace older consumption meters or to supplement and augment currently installed consumption meters. A smart meter provides more information to both the utility and the consumer. Smart meters measure the units of the resource consumed within a particular time period by the end user, and relay this “meter data” to a centralized database. A smart meter provides meter data to inform the consumer in real time or in near real time (short consumption intervals, e.g., every 15 minutes, every hour) about current use, consumption during a specific time period, consumption trends, comparisons to historical usage data, and/or other information designed to help the consumer manage resource costs and usage or to participate in demand-response programs. The meter data from the smart meter is generally communicated to the utility regularly (e.g., hourly or daily). The utility may also be able to obtain the meter data on demand. Municipal water and energy utilities are coming under pressure to install these smart meters throughout the nation, in order to qualify for federal “smart grid” conversion grants. However, though a smart meter provides useful information, it does not, by itself, provide any incentive or motivation to act. Thus, smart meters alone cannot achieve the conservation goals their proponents would like to achieve.

Many “green” initiatives and methodologies in the sector seek to exploit advantages of various innovations at the wholesale supply level. They encourage utilities to adopt solar, geothermal, wind, wave, etc. technology, or invest in reverse osmosis desalination plants. Yet, voluntary reduction of demand by individual residential, commercial and industrial consumers has not been achieved.

Some utilities have sought efficiency or opportunity by engaging in transactions that involve water and energy resources. These wholesale and/or aggregate trades have taken place at both the physical and virtual levels. In the former, Western farmers divert their water to cities like Los Angeles, or “green” energy providers supply energy to utilities as an intermediary. In the latter, speculators buy and sell abstract or virtual rights to sell water or energy at wholesale. Success has been controversial at best, Enron at worst. These transactions between big, centralized utilities cannot meet the demands placed on utilities. However, viable consumer conservation has not been achieved; rapid, dispersed and multiple trades by consumers have not been accomplished; markets within these utility monopolies that are accessible to the consumer have not been created.

Accordingly, there is an established need for a system integrating measuring, monitoring, valuing and trading resources such as energy and/or water, which encourages responsible resource usage by providing links between existing resource initiatives, by creating new resource initiatives, and by creating markets for consumer participants.

### SUMMARY OF THE INVENTION

The present invention is directed to a flexible and scalable integrated credit exchange system that provides incentives for consumers to conserve a resource. The incentive is provided in the form of an ECOSHARE credit, tradable in a provided credit exchange trading system. The resource may include electricity, water, gas, heating oil, other energy, Internet bandwidth, and other produced or natural resources, though the invention is particularly applicable to, and described as applied to, water, energy, and/or Internet bandwidth.

The integrated credit exchange system presented may operate in close partnership with state and municipal utilities and their corresponding oversight commission officials. The invention may be open to all residential and commercial consumers for whom a meter has been (or could be) installed. Thus, the term “consumer” includes residential utility customers, business and commercial utility customers, and/or industrial utility customers. For clarity of discussion only, the present invention is generally herein presented as it relates to residential utility customers—but is easily extrapolated to the other consumer categories.

The integrated credit exchange system utilizes a measuring system, consumer interface system, geospatial monitoring system, utility billing data, credit allocation system and an online trading system.

The measuring system is configured to assess (in real time or near real time) the quantity of the resource being used. This metered data is displayed to the consumer via the consumer interface system. The geospatial monitoring system is configured to monitor various risk factors that affect resource variability and management; the geospatial data acquired may be displayed to the consumer and/or may be utilized by one or more other subsystems of the present invention.

The credit allocation system creates the ECOSHARE credits and provides them to the consumer. The consumer can use the ECOSHARE credits to participate in the online trading system, either to sell the provided ECOSHARE credits or to buy additional ECOSHARE credits.

An object of the present invention is to provide an integrated credit exchange system that encourages consumers to reduce consumption of one or more resources.

A further object of the present invention is to provide an integrated credit exchange system that is practical to implement using current technologies.

Another object of the present invention is to provide an integrated credit exchange system that allows individuals to trade, buy and/or sell ECOSHARE credits.

An additional object of the present invention is to provide an integrated credit exchange system that creates conservation incentives where none currently exist.

These and other objects, features and advantages of the present invention will become more readily apparent from the attached drawings and from the detailed description of the preferred embodiments, which follow.

### BRIEF DESCRIPTION OF THE DRAWINGS

The preferred embodiments of the invention will hereinafter be described in conjunction with the appended drawings, provided to illustrate and not to limit the invention, where like designations denote like elements, and in which:

FIG. 1 is a schematic showing a first embodiment of the integrated credit exchange system of the present invention;

FIG. 2 is a schematic showing a second embodiment of the integrated credit exchange system of the present invention;

FIG. 3 is a flowchart showing an overview of the system and the system interactions with the consumer of the present invention; and

FIG. 4 is an overview of an exemplary functional description of the technical implementation of the exchange credit trading system.

Like reference numerals refer to like parts throughout the several views of the drawings.

### DETAILED DESCRIPTION OF THE PREFERRED EMBODIMENTS

Shown throughout the figures, the present invention is directed toward an integrated credit exchange system employing tightly linked subsystems (either novel or currently available) to increase consumers' awareness of resource usage and associated costs and to incentivize conservation of resources. This is done through creation of a fungible, transferable exchange credit associated with a resource, an “ECOSHARE credit,” which is provided to consumers (e.g., metered subscribers), and through enabling an efficient ECOSHARE credit trading system.

The awarded ECOSHARE credits may be sold, bought or traded by consumers within the exchange credit trading system of the present invention; the awarded ECOSHARE credits may also be applied to consumers' utility bills to reduce the number of resource units used. The ECOSHARE credits (awarded without charge to the consumer) differ from airline frequent flyer miles (which are also awarded without charge to customers) in that ECOSHARE credits:

(1) may be readily converted into cash, (2) may be easily traded to other consumers; and (3) may be awarded equally to consumers, instead of being awarded to consumers in proportion to their consumption. Thus, where airline frequent flyer miles reward consumers for consumption, ECOSHARE credits are used to encourage conservation, i.e., non-consumption.

The integrated credit exchange system provides consumers with clear and relevant data, information and analytical tools that they require in order to make sound resource decisions. They can decide whether, how and when to earn, buy, sell, donate or save ECOSHARE credits through voluntary price negotiations, and conserve resources based on their own self-interest. The value of the ECOSHARE credit varies based on both “extrinsic” data related to resource availability (e.g., temperature, infrastructure, season, etc.) and “intrinsic” demand factors related to human behavior and character, e.g., optimism or pessimism over future economic or environmental conditions. For example, if consumers receive information that a drought is expected, ECOSHARE credit value will tend to rise. Thus, a beneficial, dynamic price per unit of the target resource is created.

Until the present invention, all utilities, regulators and consumers had data, but lacked a viable or uniform tool to credibly transform, translate and reveal the integrated value of the resource on which their individual institutions and interwoven economies depend. Though the utilities have utilized different mechanisms of displaying resource use (i.e., KWH used or gallons consumed), there has been no means of dynamically valuing these resources at any consumer level at any time of the day, by the consumers themselves. Rather, prices have been sent to the public and the public has not been able to own, value or trade these commodities. Thus, the present invention, for the first time, transforms a service unit defined by a central provider into a universal unit (an ECOSHARE credit) representative of the resource that has a dynamic value reflective of changing conditions in a particular place, time or usage pattern.

Additionally, the present invention provides and distributes new incentives among multiple users to reduce their individual consumption—and thus correspondingly increase available collective supply—of resources such as finite potable water, generated electricity and computing bandwidth. The supply constraints directly impose sustainability on the market, which seamlessly clarifies users' obligations to the environment, with the ECOSHARE credit prices correctly reflecting relevant impacts of abstraction, without tax or subsidy. The result is cleaner and more reliable environmental flows. The use of the credit exchange market of the present invention minimizes the transaction cost associated with reallocating resources.

For the first time in history, people can have the egalitarian opportunity to measure, convert, earn, accumulate, monitor, track, save, trade, barter, auction, donate, buy and sell equal shares of clearly defined efficiency credits (ECOSHARE credits). The integrated credit exchange system lets users voluntarily set prices for the resources humans depend on, and incentivizes a race to conserve.

All control over resource allocation, delivery and management remains firmly in the hands of utilities or current providers. Daily operations do not change. But in terms of billing, utilities may endow consumers with an equitable share of units (ECOSHARE credits) at no cost to the consumer. The ECOSHARE credits may be denominated in the units of the resource, as suitable for the target resource. For example, one ECOSHARE credit may correspond to 100 gallons of water. In an embodiment, an equal share is allotted to each consumer. If a conservative estimate for the daily water requirement in a particular location is 150 gallons per consumer meter per day, 1.5 ECOSHARE credits may be allocated to each consumer each day, representing 150 gallons of water per day, or 45 ECOSHARE credits may be allocated per consumer meter per month (representing 4,500 gallons of water). The 4,500 gallons of water may be applied directly to reduce the consumer monthly water bill, resulting in “free” water, with usage beyond that amount being charged at steeply rising, tiered prices to compensate the utility for the lost revenue due to the free distribution of water by the allotted ECOSHARE credits, with the result of encouraging an active market in the trading of ECOSHARE credits and an overall reduction in water consumption among the utility's consumer base.

Some consumers may choose to use up their free share of water provided by the allotted ECOSHARE credits, and pay nothing. Many will exceed it and pay dearly. But frugal and innovative consumers may choose to find ways they can use less water than the 150 gallons per day, resulting in unused ECOSHARE credits—even after paying their water bill with ECOSHARE credits. They will automatically save and accumulate their unused ECOSHARE credits in their account in the online trading system. They may then track, redeem, retire or trade these unused ECOSHARE credits through the online trading system.

In another embodiment, rules may be implemented that allow an ECOSHARE credit to represent a different amount of water in different seasons or periods of time, reflecting the scarcity, demand, availability, etc. of the period. For example, each ECOSHARE credit may entitle the account holder, without charge, to 10 gallons of water from June 1 to September 30, but to 20 gallons of water from October 1 to May 31.

In a further embodiment, each metered consumer may receive 1,000 ECOSHARE credits per month, corresponding to 20,000 gallons of water per month.

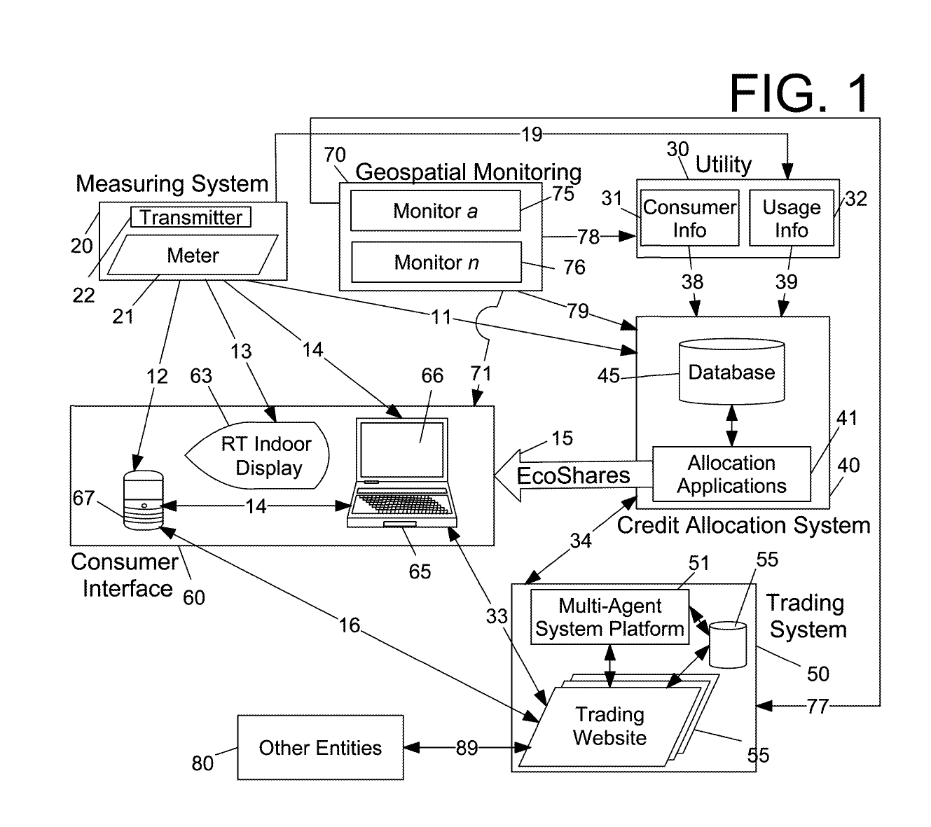

Referring now to FIG. 1, the first embodiment of the integrated credit exchange system of the present invention utilizes the following vertically integrated subsystems: a measuring system 20; a consumer interface system 60; data 31, 32 from utility 30; a geospatial monitoring system 70; a credit allocation system 40 for creating ECOSHARE credits and providing 15 them to the consumer via consumer interface system 60; and a credit exchange trading system 50 configured to allow the consumer to buy, sell and/or trade the provided ECOSHARE credits. In general, subsystems may be proprietary (designed and implemented specifically for the integrated credit exchange system of the present invention) or they may take advantage of currently available commercial systems, either as presently implemented or with customized modifications.

Humans measure what they value, and vice-versa. Data from the measuring system 20 is utilized to make the consumer aware of his resource usage and, preferably, the associated costs. The measuring system 20 includes at least one meter 21 and at least one transmission device 22 for transmitting the acquired usage data to other systems. The meter 21 is configured to acquire target resource usage data (“meter data”). Meter 21 is an existing or future remote automated metering apparatus operable to measure units of usage of the target resource, in real time or in near real time. The meter 21 may be a standalone smart meter or a supplemental smart meter that can acquire resource usage measurements in real time or near real time when attached to a conventional consumption meter (such as the AQUATELLIGENCE™ meter and the ENERTELLIGENCE™ meter presented herein or the home electricity-monitoring device TED 500® by Google®). The measuring system 20 may be operable to communicate 19 (preferably wirelessly) the meter data to the utility 30 for billing purposes and, in some aspects of the invention, to communicate 11 the meter data to the credit allocation system 40.

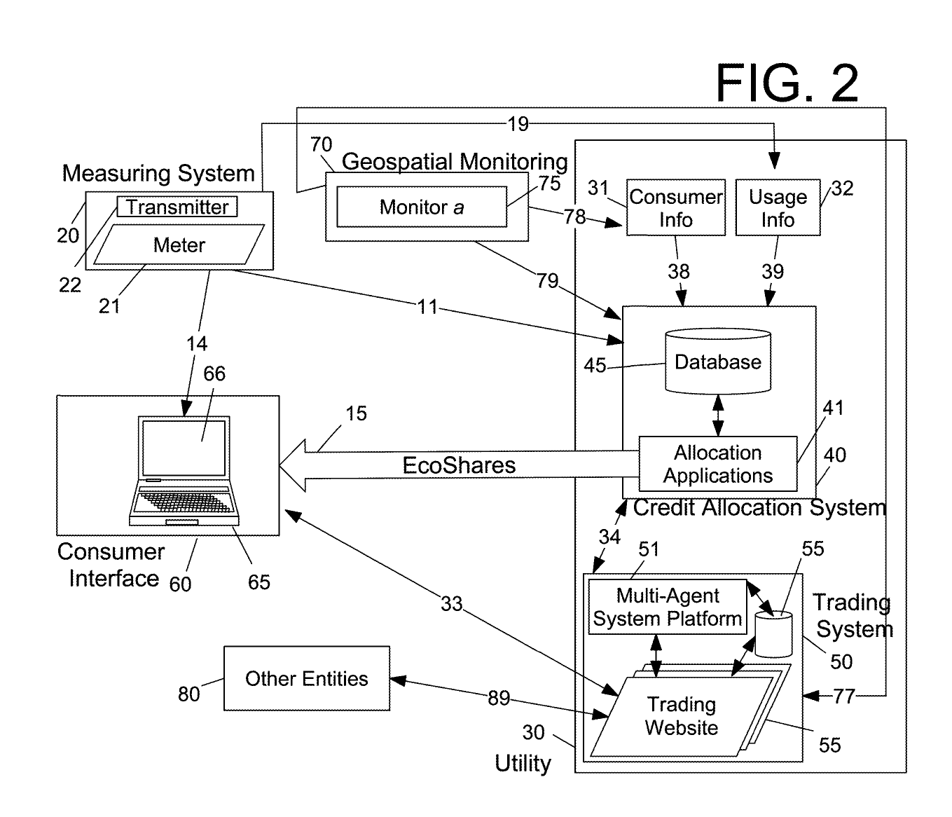

The measuring system 20 may also be operable to (preferably wirelessly) communicate with the consumer interface 60 in one or multiple paths. The measuring system 20 may be operable to communicate 13 the meter data to a real-time indoor display 63 viewable by the consumer within his home, which may be a standalone device, as illustrated in the first embodiment of FIG. 1. (Optionally, as illustrated in the second embodiment of FIG. 2, the meter data may be displayed only on the display device 66 of the consumer's computer.) Optionally, the measuring system 20 may be operable to communicate 12, 14 the meter data to a consumer mobile device 67 and/or consumer computer 65 and to receive commands from the consumer mobile device 67 and/or consumer computer 65. The variety of communication pathways 11, 12, 13, 14 available to the measuring system 20 accommodates customization of the integrated credit exchange system to meet the needs of the consumer, allowing information visibility in a manner of the consumer's choosing.

The integrated credit exchange system can install its own contractual recording tools, or incorporate those deployed by the partner utility, district, municipality or investor-owned service provider. The measuring system 20 can transmit 11, 12, 13, 14, 19, 77 cumulative up-to-date individual consumption. From these data entry points, the integrated credit exchange system may also collect and display total usage in ways that reveal daily, seasonal and annual cyclical patterns of use for each resource, along with projected multiyear trends. In other sectors where services and commodities already have prices, similar measuring devices track patterns of, say, consumer spending, coffee exports, home sales, oil imports or college graduates. The integrated credit exchange system will record and convey to centralized database 45 and/or database 55 what have previously been regarded as neglected and worthless units of water, energy and bandwidth consumed or produced by consumers/end users within a client community. Community is defined within the system by a shared resource pool: hydraulic basin (watershed), energy grid or broadband network.

The credit allocation system 40 may be configured to convert live resource efficiency units into defined, defensible and divestible ECOSHARE credits, and to allocate 15 ECOSHARE credits to the consumer. The conversion of the resource efficiency units into, ECOSHARE credits, the number of the ECOSHARE credits allocated 15, and in some aspects of the invention, the value of the ECOSHARE credits allocated 15 may be determined by one or more exchange methodologies and simulation-optimization market clearing algorithms, referred to generally as “allocation applications” 41. The allocation applications 41 are executed by the one or more computing systems (operably configured with associated hardware and software) of the credit allocation system 40.

These allocation applications 41 include catalytic software that converts live resource efficiency units into fungible abstract credits, the ECOSHARE credits. ECOSHARE credits are the virtual property rights that are transferable between owners. Similar online exchange methodologies exist in other sectors with priced commodities, such as Trulia (real estate), Amazon (books), eBay (furniture), Expedia (airfare), ForEx (currency), Hotwire (rental cars), or the Nasdaq exchange (securities). The current invention's unique methodologies unlock the ability to trade measured, monitored units or efficiency credits by creating an ECOSHARE credit that has real monetary value.

The allocation application 41 may use any one of a number of allocation algorithms to determine the number and/or value of the ECOSHARE credits to be awarded to each consumer based on one or more variables, including conservation goals, individual or aggregate historical or current usage data 32, and/or global and/or local inputs of both extrinsic factors and intrinsic factors, including data from the geospatial monitoring system 70. The allocation application 41 (or the utility 30) may also use one or more allocation algorithms to empirically determine increases in utility rates to maintain revenues after integrated credit exchange system implementation.

In one exemplary allocation algorithm, the utility determines values for the following variables:

v=the total number of subscribed meters;
wᵢ=the total units of the resource provided per month, i.e., initial or historical utility sales;
wᵢ=the “adjusted” (after implementation of the integrated credit exchange system of the present invention) total units of the resource provided per month, i.e., the projected unit sales after implementaion;
xᵢ=the initial (historical) total monthly revenue derived from providing wᵢ;
xₐ=the adjusted total monthly revenue derived from providing wᵢ;
yᵢ=the initial average cost per charged unit, assuming a non-tiered system (the integrated credit exchange system can be implemented with tiered or non-tiered rates; non-tiered rates are discussed for clarity, but extrapolations can be made to tiered rate plans by averaging all tiers, averaging a selection of tiers, or determining a weighted average);
yₐ=the adjusted average cost per charged unit y, assuming a non-tiered system;
qᵢ=initial average units of the resource used per subscribed meter per month over a defined time period;
qₐ=adjusted average units of the resource used per subscribed meter per month;
zᵢ=the average units of the resource charged per subscribed meter per month over a defined time period;
zₐ=the adjusted average units of the resource charged per subscribed meter per month;
k=factor to adjust for seasonal factors, weather factors, population factors, etc.

The following Equation 1 represents the initial or historical factors:

xᵢ$/month=(v)*(zᵢ charged units/month)*(yᵢ$/charged unit).

When the integrated credit exchange system is implemented, the utility's goal is to reduce qₐ and, therefore, if v (total number of subscribed meters) remains constant, wₐ (total units of the resource provided per month to the total number of subscribed meters) will be reduced. In one embodiment, the utility allocates ECOSHARE credits equivalent to (0.4) (zᵢ) units, equally to all subscribed meters, effectively allocating (0.4) (zᵢ) of free units to each meter. The ECOSHARE credits are denominated in the units of the target resource being utilized, for instance gallons of water; the gallons of water usage on the consumer's bill can be reduced by the number of gallons corresponding to the denomination of the ECOSHARE credits (not necessarily a 1:1 correspondence). Consumers who were using little of the resource now may have ECOSHARE credits to sell, while consumers who have large needs for the resource may continue to buy the resource from the utility, but may also log into the trading system 50 to buy potentially less expensive units of the resource as ECOSHARE credits from low-usage consumers having extra ECOSHARE credits.

To continue to receive adequate revenue (i.e., xᵢ is approximately equal to xₐ), the utility may desire to raise the rates for the resource (i.e., yₐ, the adjusted average cost per charged unit). As 40% of the value of zᵢ (initial average units of the resource charged per subscribed meter per month) is now issued as an exchange credit, the income from providing the resource will be greatly reduced if the average cost per charged unit remains yᵢ for the sales beyond the ECOSHARE credit allocation. Thus a higher yₐ (adjusted average cost per charged unit) will be needed. The utility's goal is to encourage consumers to implement conservation methods to reduce w (total units of the resource provided per month to the total number of subscribed meters), yet this will not occur immediately. Thus for simplicity, the Equation 2 below assumes w remains constant, with wᵢ=wₐ.

To determine the proportional rate increase (the increase from yᵢ to yₐ) the following exemplary Equation 2 presents the adjusted factors:

xₐ$/month=(v)*(k)*(zₐ charged units/month)*(yₐ$/charged unit).

Where, in this embodiment, if v (total number of subscribed meters) remains constant the Equation 3 follows:

zₐ charged units/month=(zᵢ charged units/month)*(0.6).

If it is desired that xₐ=xᵢ then the above Equation 2 can be set equal to the xᵢ of the historical average or the previous month. Thus yₐ, the adjusted average cost per charged unit of resource, will be significantly higher, further encouraging consumers to take advantage of ECOSHARE credits for sale within trading system 50.

Variations on the above Equation 2 are within the scope of the invention. For example, a lower revenue goal may be acceptable (i.e., xₐ<xᵢ is satisfactory); if so, the value of the lowered revenue goal can be substituted for xₐ in Equation 2. In a second example, subscribed consumers may be expected to reduce consumption as yₐ (cost per charged unit of resource) increases. This can be reflected by giving weight to a reduction in zₐ (charged units/month) due to the increase in yₐ ($/charged unit).

Thus, to keep xₐ≈xᵢ (assuming the total number of subscribed consumers, v, remains constant) the cost per charged unit, yₐ, is raised, but as consumers conserve the units of the resource used per subscribed consumer per month, qₐ will be reduced. Therefore, as time passes, further adjustments to the cost per charged unit, yₐ, may be needed.

However, other factors also influence the above equation. For instance, though as consumers conserve the units of the resource used per subscribed meter per month, qₐ will be reduced, a further increase in the cost per charged unit, yₐ, may be not be needed to keep xₐ≈xᵢ, due to the reduction in the cost of providing a reduced number of total units, wₐ. These other factors are represented by the variable k in the above equation.

The variable k can be used to adjust for the following additional factors, generally ranked first to last by priority:
I. Past Baseline
   A. Historic water supply availability in defined basin
      1. Paleo-climatological records dating to pre-European settlement
      2. Annual and seasonal rainfall levels
      3. Mean and average evapotranspiration rates
      4. Aquatic biomass and diversity supported
      5. Dynamic extremes from peak drought and deluge
   B. Historic demands on water in defined basin
      1. Population growth within watershed
      2. Agricultural diversions
      3. Collective groundwater pumping rates
      4. Gross and net industrial use
      5. Use and consumptive loss of water for energy
      6. Domestic/residential withdrawals
      7. Aquifer depletion rates
II. Present Status
   A. Local economic uses of water
      1. Current population
      2. Number of water district/utility accounts
      3. Volumetric farm water use measured against crop sales
      4. Sewerage and sanitation volume
      5. Energy demands of treatment
      6. Average GDP within county
      7. Leakages or unaccounted water
      8. Tax revenues collected within municipality
      9. Water rates charged industrial/energy use
      10. Water rates charged commercial/retail use
      11. Water rates charged municipal use
      12. Water rates charged residential/domestic use
   B. Local cost recovery of water
      1. Water utility fixed costs
      2. Water utility fixed revenues
      3. Water utility variable costs
      4. Water utility variable revenues
      5. Energy utility average rates
      6. Energy utility peak rates
      7. Tiered water rate brackets
III. Future Stress
   A. Predictive models for future water supply
      1. Expected regional temperature rise
      2. Corresponding evapotranspiration rates
      3. Anticipated regional climate flux impacts
      4. Predicted annual and seasonal rainfall patterns
      5. Basin runoff and permeability
      6. Storm water contamination
      7. Saline intrusion
   B. Predictive models for future water demands
      1. Economic growth in basin
      2. Population growth in basin
      3. New water utility accounts
      4. Agricultural conversions
      5. Proposed commercial development
      6. Anticipated residential development

Of course, it is not necessary that the utility allot the large number of ECOSHARE credits as described in the above example, which would have an immediate, substantial effect. Particularly as an introduction, initial allotment of smaller numbers of ECOSHARE credits may be preferred.

In a second example, if a proportionally smaller number of ECOSHARE credits is allotted, such as 2% of zᵢ (initial charged units per month), and if it is desired to maintain xₐ=xᵢ (or xₐ≈xᵢ), and if v (total number of subscribed meters) remains constant, then:

zₐ charged units/month=(zᵢ charged units/month)−{(zᵢ charged units/month)*(0.02)}=0.98*(zᵢ charged units/month).

Then:

(zᵢ charged units/month)*(yᵢ$/charged unit)=(zₐ charged units/month)*(yₐ$/charged unit)=0.98*(zᵢ charged units/month)*(yₐ$/charged unit)

And the adjusted cost per unit charged is given as:

(yₐ$/charged unit)=(yᵢ$/charged unit)/0.98.

In a third embodiment, the number of ECOSHARE credits allotted can be further based on the number of persons per meter. In this embodiment, while the equations remain the same, the values for v, zᵢ, zₐ, and the number of ECOSHARE credits allotted would be based on the number of individuals in the residence with the subscribed meter, instead of the number of subscribed meters.

The number of persons per resource meter can be estimated based on the number of square feet in the dwelling corresponding to the meter, can be based on census data, can be determined through subscriber surveys, or other similar methods now existing or to be derived in the future.

The credit allocation system 40 is operable to allocate 15 ECOSHARE credits to each consumer. The credit allocation system 40 includes one or more databases 45 and one or more allocation applications 41 run on one or more computing systems operably configured with associated hardware and software. The credit allocation system 40 is operable to receive 38, 39 consumer-associated data (consumer information 31 and usage information 32) from the utility 30; this information may include personal information such as names with contact information, billing information, current usages, historical usage, and/or similar consumer-associated data. The credit allocation system 40 is optionally operable to receive 79 monitoring data from the geospatial monitoring system 70, with the geospatial monitoring data available for utilization within the allocation applications 41.

Once ECOSHARE credits are created and awarded by the credit allocation system 40, the consumer who has received the ECOSHARE credit award can seek out where, when, how, why and from whom they can secure the best price for ECOSHARE credits, via the trading system 50.

The credit trading system 50 is operable to allow consumers to perform one or more exchange activities, such as buying, selling, saving, donating, or trading ECOSHARE credits at an Efficiency Credit Exchange. The trading system 50 is also operable to inform consumers of the current price of ECOSHARE credits and of factors or influences that may affect the future price. The trading system 50 includes one or more multi-agent system platforms 51 and a computing system. The computing system is operable to execute the multi-agent system platforms 51 and is configured with conventional hardware and software, including database 50, networking hardware and software, as further described below. The trading system may further comprise an operable social networking component.

The Efficiency Credit Exchange provided by the exchange credit trading system 50 is an integrated online platform that encourages a defined group of citizens (the “consumers”) to find creative ways to conserve resources (particularly water, power and broadband), slash emissions, bring social equity, and spur innovation. It works voluntarily, and offers an autonomous bottom-up approach to reducing demand. In partnership with a water utility, electricity utility, broadband provider or other metered resource provider, these efficiency credit exchanges seek to help motivate consumers to eliminate waste of scarce resources. They provide an online “ecosystem” in which all consumers earn, track, use, trade or retire saved water, power or broadband units (embodied in the ECOSHARE credits).

The multi-agent system platform 51 is preferably a Web 2.0 trading platform (such as the AQUAJUST™, ENERJUST™ or BANDJUST™ trading platforms). The ultimate decision in any exchange lies with a buyer and seller. The multi-agent system platform 51 does not make a decision or recommend decisions, but instead lays out a neutral menu showing the full range of options. Options vary by price, quantity, quality, timing and user. Trades can be automated for expediency or operated manually. The one or more multi-agent system platforms 51 integrate simulation and linear programs that preferably utilize a periodic and automated auction which is cleared by utility operations managers. The multi-agent system platforms 51 may be specifically designed for use with the integrated credit exchange system of the present invention, or they may comprise customized currently available platforms.

The aforementioned industries with priced commodities (i.e., airline booking, car purchasing) combine elements of game theory, emergence, computational sociology, complex systems, and evolutionary programming to harmonize and integrate the competing and collaborating needs of multiple users. By simulating the actions and interactions of autonomous agents—both consumers and collective organizations or groups 80—the system provides consumers with maximum flexibility in negotiations, harnessing increased computation power in order to let all people establish and transmit an accurate price.

Also, the multi-agent system platforms 51 of the trading system 50 may be functional to present other types of auctions or sales platforms. For example, in one aspect, a periodic and automated auction which is cleared by a utility's operations managers may be implemented. In a second aspect of the invention, the trading system 50 may be embodied in a one-sided auction in which water and energy utility consumers buy from the market manager. Another aspect of the invention may include a one-sided automated procurement, such as a reverse auction, in which consumers automatically sell their ECOSHARE credits to the market manager at the best rate available. In a fourth aspect, among higher-use clients, the trading system may be two-sided, but configured to manually (such as by the market manager) or automatically balance frugal and efficient utility customers with higher-consuming commercial or industrial participants. In a fifth aspect, in the two-sided smart exchange system described above, the utility manager or other outside entities 80 may be a net seller or buyer of reserves, or simply a revenue-neutral broker.

Fulfillment of transactions is backed by the utility exchange itself. Utility subscribers (the “consumers”) remain generally anonymous to one another, identified only by their account number for credit or debit within the system. The market managers already enforce regulation to ensure fairness and transparency, but through this system may be able to avoid political pain, economic distortions, and supply disruptions. Without interfering with the operations of the physical plant system itself, this invention provides the vertically integrated platform—unique device, linked mechanism, integrated methodology and overarching system—for an outcome that is safe, efficient, equitable and orderly.

This unique invention's vertically integrated subsystems have significant and multiple benefits for civilized societies and the ecosystems on which they depend. The vertical integration of the subsystems creates conservation incentives where none exist. It motivates progress in a voluntary, transparent manner. It reduces transaction costs among anonymous parties in a potential exchange. It unlocks flexible marketplace competition within closed and rigid “natural monopolies.” It balances supply and demand pressures to lower critical “peak usage” costs. It levels the economic playing field in a community with unequal incomes. It eliminates natural resource externalities such as waste, pollution, inefficiency and free riders.

The optional geospatial monitoring system 70 comprises one or more monitoring instruments (monitor a 75 . . . monitor n 76) configured to monitor in real time the various risk factors that affect resource variability and management. The geospatial data acquired may be utilized by one or more of the subsystems of the present invention. The geospatial monitoring system 70 is configured to communicate 78 with the utility 30, to communicate 79 with credit allocation system 40, to communicate 71 with the consumer interface 60, and/or to communicate 77 with the trading system 50. The monitoring instruments 75, 76 may include one or more of the following geospatial data acquisition tools: remote sensing tools, aerial imagery systems, field data systems, surveying tools, geographic information systems, optical Light Detection And Ranging (LiDAR), utility tools, weather reporting tools, resource distribution monitors, stream-flow devices, and similar monitoring instruments as needed to monitor factors affecting the target resource.

The monitoring instruments 75, 76 not only pore over the initial productive supply and consumptive demand; they also scrutinize round-the-clock transmission delivery in between points to keep track of system losses and identify resource leakages. The present invention preferably utilizes currently available monitoring instruments 75, 76 that may already be in place or in the process of installation, but optionally utilizes monitoring instruments 75, 76 particularly designed and/or installed for use with the present invention. The geospatial data outputs of these monitoring instruments 75, 76 are generally in the public domain, but utilization is currently largely dominated by an elite minority of technical experts for academic or regulatory use. The present invention democratizes existing and future geospatial data, harnesses informational capacity and translates their utility for the wisdom of crowds. The present invention may apply the geospatial data acquired by these monitoring instruments 75, 76 to clarify the available quantity, quality, risk and reliability of resources for each end user/consumer.

Thus, intrinsic measuring (via measuring system 20) and external monitoring (via geospatial monitoring system 70) lay a groundwork for consumer and/or utility decisions; value is created for the specified resource when the ECOSHARE credit is created (via credit allocation system 40) and as the consumer is enabled with the knowledge, opportunity and reason to trade it (via trading system 50).

Two embodiments are presented to illustrate the variability in the architecture of the integrated credit exchange system, the first embodiment of FIG. 1 and the second embodiment of FIG. 2. The first embodiment presents the individual systems (20, 30, 40, 50, 60, 70) separately to illustrate the flexibility and scalability of the integrated credit exchange system of the present invention. The first embodiment shows that the credit allocation system 40, the trading system 50, utility 30, and geospatial monitoring system 70 may be operated by separate organizations, entities, or authorities. The second embodiment of FIG. 2 illustrates an exemplary architecture in which the utility 30 may operate the credit allocation system 40 and the trading system 50.

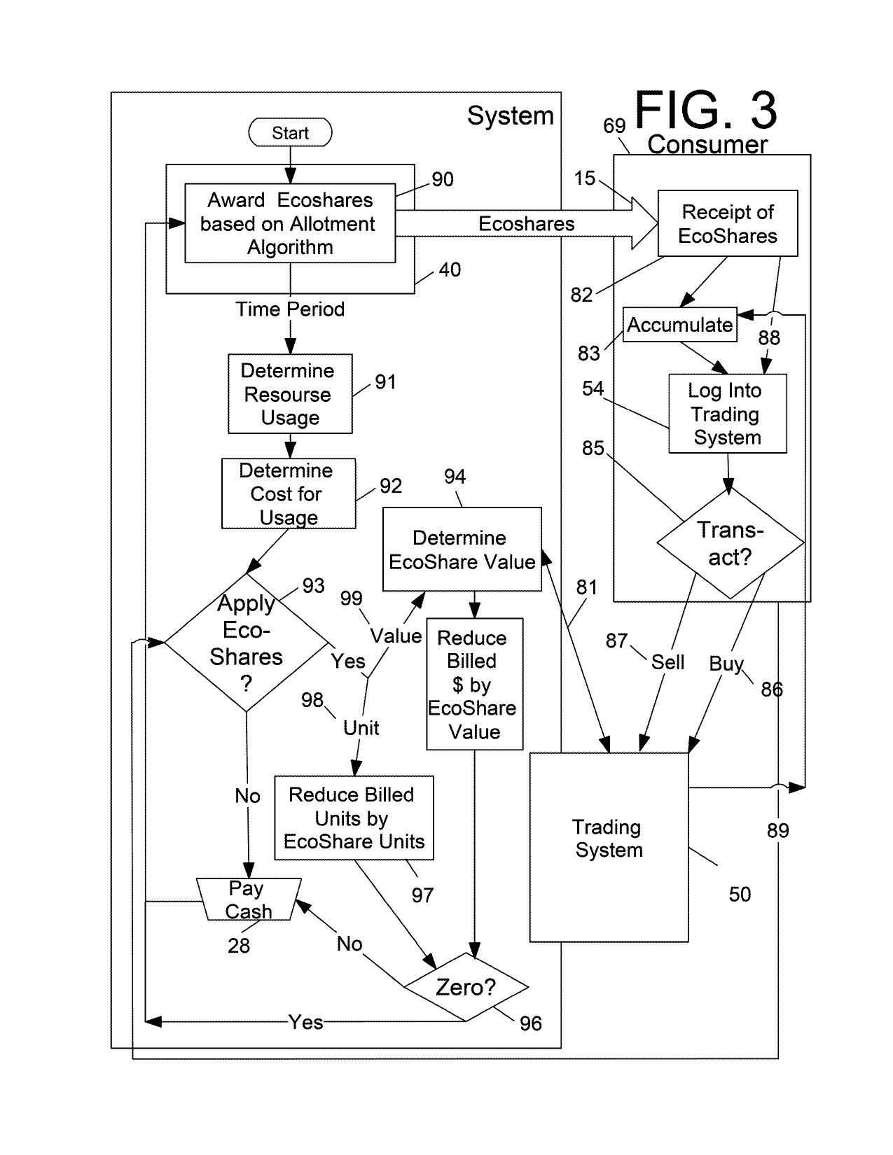

FIG. 3 illustrates a portion of the method of usage of the second embodiment of FIG. 2, portraying both steps performed by the system (in this case the utility 30) and by the consumer 69.

The credit allocation system 40 allocates 15 ECOSHARE credits to the consumer 69 via data communication 34 to trading system 50, who receives 82 the ECOSHARE credits, which are now his property to dispense with as he desires. The consumer 69 may wait a period of time until more ECOSHARE credits are accumulated 83, or may immediately 88 log into 54 the trading system 50. The trading system 50 displays information supplied by the multi-agent system platform 51 to aid the consumer in making decisions on the timing and quantity of sales or purchases of ECOSHARE credits.

The consumer may sell 87 his ECOSHARE credits or may buy 86 ECOSHARE credits of others. For instance, if he has been issued ECOSHARE credits for more water than he needs, he can convert the extra ECOSHARE credits to cash by selling 87. However, if he has a higher water need, he can check the trading system 50 to determine if he can find other consumers' ECOSHARE credits priced at a favorable price; if so he may buy 86 ECOSHARE credits belonging to one or more other consumers. Alternatively, he may donate his ECOSHARE credits to a worthy cause or non-profit group registered within the system. The trading system 50 may present the buying and selling with an auction format or with a fixed price format.

At some time after the credit allocation system 40 has awarded 90 the ECOSHARE credits based on the allotment algorithm to a particular consumer, the system determines 91 the units of usage for the particular consumer for a particular time period (generally a month) and determines 92 the resource usage cost. The system determines 93 if the consumer desires to apply ECOSHARE credits and determines the number of ECOSHARE credits to be applied to the consumer's bill for resource usage. This determination is based on a designation by the consumer via a conventional communication means 89, such as by phone, postal mail, email, web-based account access, web-based trading system 50 access, in person, or via fax.

If the consumer has designated that no ECOSHARE credits be used, the billing continues in the conventional manner with the consumer paying 28 cash or a cash equivalent for the resource usage charge.

If the consumer has designated to use all or a portion of his ECOSHARE credits, the bill is reduced. Any one of multiple methods may be used to reduce the bill. Two exemplary bill reduction methods are presented, a unit method 98 and a preferred value method 99.

In the unit method 98, the ECOSHARE credits are denominated in the units of the target resource being utilized. For example, the water authority may award a particular consumer 7,000 ECOSHARE credits corresponding to 7,000 gallons of water. If the consumer desires to use his 7,000 ECOSHARE credits, and his water usage for the month is 7,000 gallons, the units would zero out 96 and the consumer would owe nothing. However, if the consumer used 15,000 gallons of water, he would pay 28 the cost for the 8,000 gallons exceeding his 7,000 ECOSHARE credits.

In the preferred value method 99, the ECOSHARE credits are preferably denominated in the units of the target resource being utilized, but not necessarily at a one-to-one correspondence. At the time of allotment, the ECOSHARE credit has an assigned realizable monetary value. The system determines the value of the awarded ECOSHARE credits by communicating 81 with the trading system 50. Various methods of determining value may be used. For instance, the value of an ECOSHARE credit may be set equal to an average (with or without outliers cast out) of the sales price of ECOSHARE credits sold in the trading system 50 within the last hour, the last day, or the last few days. Optionally, a market price may be set for an ECOSHARE credit, similar to the setting of a market price for a company stock.

For example, using the preferred value method 99 of bill reduction, the water authority may award a particular consumer 7,000 ECOSHARE credits, which are valued at $100 at the first of the month. At the end of the month, assuming the consumer desires to use his 7,000 ECOSHARE credits, and assuming the cost of his water usage for the month is $100, the system determines 94 the value of the 7,000 ECOSHARE credits by communicating 81 with the trading system 50. If the value of the 7,000 ECOSHARE credits has fallen to $95, the consumer in this example would then pay 28 the remaining $5 bill.

Periodically, such as after reconciliation of the consumer's monthly bill, the system restarts the steps by again awarding 90 the consumer's ECOSHARE credits.

The pricing of the units of the resource by the utility (yₐ, the adjusted average cost per charged unit) may fluctuate from period to period, based on factors within the variable k. For example, input 77 from the geospatial monitoring system 70 may provide data (available to both the consumer and to the utility) indicating a low winter snowfall in the watershed of the water utility. If the consumer knows that the price is likely to fluctuate based on geospatial factors affecting the target resource, he may be incentivized not only to conserve the resource, but also to attempt to buy ECOSHARE credits at a favorable price. Therefore, upon learning of the low winter snowfall, he may decide to buy ECOSHARE credits for his upcoming summer water needs, anticipating an increase in the cost of the units.

The value of the ECOSHARE credit will vary as consumers buy and sell ECOSHARE credits in trading system 50. This market-design trading system 50 enables this dynamic price per unit of water (or other resource) consumed and a true time-of-use, peak-off-peak price structure.

Based on these disclosed devices and methods, the integrated credit exchange system of the present invention utilizes the allocation applications 41 that establish and transmit the collective users' ECOSHARE credits and the multi-agent system platform 51 of the trading system 50 that reveals the resulting prices and quantities available to and from all parties and that provides a trading platform.

An example of a water meter (AQUATELLIGENCE meter) and an electricity meter (The ENERTELLIGENCE Meter) for use with the measuring system 20 and configured to output meter data is presented as follows:

The AQUATELLIGENCE meter and the ENERTELLIGENCE meter provide consumers with a powerful combination of accuracy, affordability, reliability and functionality including calendaring, resource outage and restoration alarms, events logs and more. The AQUATELLIGENCE meter ties a consumer's water usage to a dollar amount by providing easy-to-display information related to gallons used, gallons saved, unit cost and total cost. The ENERTELLIGENCE meter ties a consumer's electricity usage to a dollar amount by providing easy-to-display information related to kilowatt hours used, power saved, unit cost and total cost.

In both the AQUATELLIGENCE meter and the ENERTELLIGENCE meter, the remote automated metering relay instrument (transmitter 22) conveys 11 to credit allocation system 40 (stored in a centralized database 45) and/or conveys 77 to trading system 50 (stored in database 55) the units of water, energy and bandwidth by user, within a closed system, whether county water district, municipal provider, or statewide gas and electric company.

These hardware- and software-based meters can interface with existing utility water meters, convert the analog information into digital data and process the transformations described above, and transmit 13 the results wirelessly to one or more indoor displays 63, placed at the consumer's convenience in order to make reading and tracking of the meter much easier than if such information is only available outside. The meter data output can also be communicated 12 to mobile phones and/or mobile handheld browsers. Additionally, the AQUATELLIGENCE meter and the ENERTELLIGENCE meter may also be able to spread costs, savings, allocations and usage across sub-units inside an apartment or other shared dwellings/business parks.

The integrated credit exchange system is generally presented herein as a meter-based system. However, it can additionally be implemented as an individual-based system in which the ECOSHARE credits can be allotted in a proportioned manner to multiple individuals associated with a single meter.

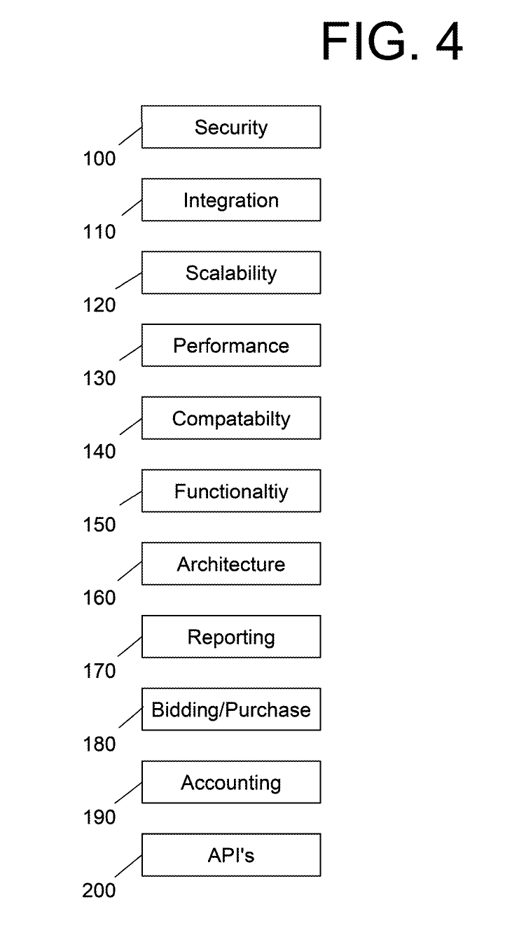

Turning now to FIG. 4 an overview of an exemplary functional description of the technical implementation of the exchange credit trading system 50 is presented.

The software to implement the web-based trading system 50 allowing access by the subscribed consumers, whether purchased outright, developed from scratch, or derived through enhancements from an existing package, may include support for the following capabilities: security 100, integration 110, scalability 120, performance 130, compatibility 140, functionality 150, suitable architecture 160, reporting 170, and bidding/purchasing 180.

Security 100 for the trading system 50 may preferably include the following:
“Hardened” against hacking, manipulation, and DOS attacks;
CAPTCHA for public facing input forms;
SSL for all E-Commerce and all public side secure data transmissions;
VPN for Utility side data transmissions; and
Secure SSL/VPN authentication for Site Administrators.

Performance 130 may preferably include the following:
7×24 operation;
Online Backup of databases and all site components;
Replication for both backup and redundancy;
Software and hardware redundancy (as budget allows); and
A flexible architecture that allows for scaling through redistribution of application components.

The trading system 50 may preferably be compatible 140 with commonly used browsers and, in one aspect, with popular mobile phones and devices, with customizations to accommodate smaller screens and lower bandwidths. For regular cell phones, the application may preferably support a messaging (email and texting) interface complete with a help guide for actions such as searching, price watching, buying/selling, etc. Users can text “help” to a predefined email address, such as mysm@smartmarkets.com, and receive an email back with the set of supported commands. Users may then be able to use the listed commands to perform the full range of functions needed to sell, purchase and obtain information about ECOSHARE credits listed on the site.

Versions of the site may support full on-phone applications. Alternatively, an embodiment may use an audio-based application that would accept voice commands for trades and other activities. Such an audio system may be a “develop once” technology that would be inherently compatible with all makes of cell phone. The audio system may provide basic instruction for use similar to “traditional” telephony applications today. Security may be by means of user PINs typed directly into the phone, and may be required at the start of a given “session.” The data end of the audio system may be hooked directly into the main application and be seen as a cell-based user (by administrators), but appear in the trading system 50 as any other user for all other trading system 50 users. Another optional cell phone offering may be a combination of telephony, texting and mobile web.

The functionality 150 of the integrated credit exchange system may preferably include the following:
Administrative Back-End Supports:
   (i) Access controls—Ability to grant permissions to users to perform different functions and content in the system, for example, who can trade ECOSHARE credits and with what other entities 80 can they trade the ECOSHARE credits, and ability to grant additional privileges to users;
   (ii) Basic setup/upload of entities, including creation of utility/water company information, related accounts, uploading of ECOSHARE credits granted each month, and integration with billing systems;
   (iii) Auditing;
Reporting;
Account setup and management;
User verification/reputation tracking;
Bidding/purchasing system;
Accounting/billing;
Messaging;
Notifications;
Ad generation, tracking and billing;
Social networking;
Basic/advanced reporting;
Data mining;
Support/help desk; and
API's integration with other systems or other components of the existing system.

As ease of market entry may be a priority, the system may be set up to run completely independently of the utility companies, other than listing them and having people select their utility company as part of their registrations (as illustrated in the first embodiment of FIG. 1). The system may be presented to prospective utilities, and those chosen to participate may participate in the necessary tie-ins, so that accounts can be auto-updated with a subset of their basic account information as well as their calculated “typical” consumption information, providing a needed method for verification of actual resource usage as well as an initial and perhaps ongoing method data basis for ECOSHARE credits valuation. Additional interface with the utility 30 may be required to factor in supply and other conditions to factor in their effect on ECOSHARE credit prices.

The account setup and management may preferably include the following:
User registration capture/maintenance
   Users may be able to sign up for participation in the system. As part of registration, their utility account numbers may be taken for real-time or possible future verification, and to prevent double-signups. (Note: Registered users may have the ability to manage their utility accounts through their membership account.)
   An anti-DOS/tamper component such as CAPCHA may be implemented on the signup page to help prevent fake posts and forum post attacks. All user activity involving access/updates to their account may require secure login. An option to require email verification for future account updates may be provided as an option (i.e., changes to the user profile may be held and an email may be sent requiring the recipient to click on a verification link to approve such changes before the changes are allowed to take effect).
   Users may be able to make changes to their accounts/profiles. As mentioned above, account changes may optionally require email verification (again to prevent tampering). Changes may include change of email, change of address, change of service provider, change of password.
   Forgot password link may email forgotten passwords to the registered email address.
   Registered user may be issued both security token session cookies and longer term (multi-year) general identification cookies. Security token cookie may be maintained only for as long as a given user maintains contiguous access to the site. If a given user leaves the site, the token cookie may expire, and the user may have to log in once again to obtain a replacement cookie. The following activity may require a valid security token cookie:
      Changing a profile value
      Initiating a bid
      Entering a user rating
      Making payments
      Sending a message through the system
   For security reasons, a users may have screen names to be used publicly on the site, which may be separate and distinct from their usernames.
   All trades and account update activity may initiate either a confirmation email (mentioned above), or at minimum an informational email, to alert the user of the acceptance of the change.
   User reputation—The system may preferably maintain user reputation rankings based upon the following criteria:
      Adherence to usage quotas. Users who trade off ECOSHARE credits and then exceed their usage agreements may be tracked. Future trading may include a percentage penalty and required record of successful adherence used to regain their reputation status.
      Adherence to trade conditions.
System administrators and “administrative members” (see, company memberships in the “Types of Accounts” section below) may have the ability to grant/revoke trading rights to members as well as the ability to create and remove/disable membership accounts.

Preferably several distinct types of accounts may be provided and supported, including the following:
Anonymous visitor
   Anonymous visitors may be tagged with both a URL and cookie tag for future use in web traffic analysis.
Basic user
   Can participate in social networking but not trading component of the system. May be granted additional capabilities such as reporting by administrators.
Trading user
   Have utility accounts and have permission to trade ECOSHARE credits within these accounts.
Association
   Associations may support sub-membership. An association could be a condo association, a development or other organization where a number of individuals choose to form a group for tracking, billing and trading purposes. Pooling of ECOSHARE credits may be an option in this type of memberships, and reports may cover both individuals and the group as a whole. Support may also be provided for report-only accounts.
Municipality/infrastructure related memberships
   Memberships all associated with a specific municipality. Such groupings may allow for special rules/policies/tracking/incentives for the given municipality.
   In some cases a municipality may have infrastructure such as a water tower, reservoir, etc. where the particular resource needs to be tracked as a subset or independently or as a distinct subset of other resources, though the overall utility provider is the same. Such memberships may need to support “specialty” ECOSHARE credits priced for the specific resource and with perhaps a separate set of tracking parameters, incentive offering, etc.
Company
   Similar to association, however, membership can have a potentially unlimited number of levels/groupings. Included would be support for access and role privileges for accounts. Such flexibility may allow multi-site corporations the ability to set up administrators to oversee activity in potentially many regions of the country. Subaccounts may have collective as well as individual reporting capabilities, as well as the ability to potentially obtain or provide group/organizational incentives and group/organizational based activity/actions/tracking.
   Support “portfolio” concept, where administrator level users can review/manage overall holdings, across regions/divisions.
Utility registration capture/maintenance
   Identified as a separate tier of membership, possibly fee-based.
   Supported interface or Excel/CSV upload of user accounts for instant setup (template based).
   Real-time interfaces (SOAP/CORBA, etc.) for ongoing data exchange, VPN, IP security-based.
   ECOSHARE credits maintenance system for distribution and valuation of ECOSHARE credits.
   The nature and extent of the data exchange with prospective utility companies may vary.

The reporting 170 may preferably include the following:
Several “bundles” of reports may preferably be available, with some offered as “value adds” for professional membership (the term used in this document for a higher-tiered level of individual membership).
User reports
   Graph of ECOSHARE credit value over user specified timeframe.
   Current and historical (up to n months) account trading reports and account balance and transaction history information. Available to all members for the utility account within their purview. Portfolios may be supported for corporate members. Permissions can be granted to other accounts for viewing of accounts they do not have within their own memberships.
   Possible market/industry reports
Standard report plus historical
   Sold by number of years of history to be kept/reported on. An add-on for all levels of reports.
Market reports for associated resources
   Reports on resource usage for the utility/resources to which the member is directly associated.
Market reports for diverse resources
   Reports perhaps sold in bundles based upon number of resources to be covered.
   Report may be available individually as well as by user-selected groupings.
Market/national
   The highest level of reporting, may cover all resources with support for N number of groupings (sold on a “per grouping” basis).
Data mining system
   The data mining system may basically provide a cross-tabular format for all of the data collected, both trade-related as well as some demographic- and utility-based data as are made available. Both historical and current data may be made available. The data mining system may be physically separate from the rest of the system, though data may flow between the two.
For web site administrators, web traffic reports may be set up to show daily/weekly/monthly traffic levels. Much of this information may also be available from the data mining reports.
Accounting/audit trail/reporting systems
   The system may be infused with trails throughout. All updates may include date/time, updated by, and updater IP address information.
   The system may be interfaced with a backend accounting system.
   The system may have a variety of administrative reporting systems.
   All ECOSHARE credits may be assigned unique identifiers, to be used in tracking them through the system.

The bidding/purchasing 180 may be operable to support some or all of the following functionality:
Auctions allowing periodic/ongoing ECOSHARE credit valuation based on seasonal usage, anticipated resource demand, ECOSHARE credits trading demand, supply and availability of ECOSHARE credits, etc.
Auctions lasting various lengths of time.
Auctions permitting auto-renew, when no bids are received within the time frame.
Time window ECOSHARE credits trading feature allowing ECOSHARE credits to be traded for use/consumption within a smaller (or larger) period than the default billing period.
Auctions with an optional “minimum bid.”
Auctions with a “Buy It Now” at a fixed price feature.
Auctions allowing “masked” bidding, where bidders are assigned masks such as “bidder 1,” “bidder 2,” etc.
Manual or automatic purchase of ECOSHARE credits.
Manual or automatic release of ECOSHARE credits to bid winners.
E-Commerce—to support outright purchase of ECOSHARE credits, using, for example, Authorize.net, PayPal, Google Checkout, etc.
User rating system (feedback on seller/buyer for trades).
Questions/messages to sellers/bidders permitted.
Specialized local/regional rules such as time based usage rates.
Stock market-type activity such as selling short.
Online reports purchase.
Professional membership purchase.
Donations—Members may choose to donate ECOSHARE credits to other entities, such as churches, public schools, libraries, etc.

The accounting/billing 190 may preferably include the following:
Share Valuation
   Initial ECOSHARE credit valuation may be set up as a standard formula for a given resource, and may be based upon predetermined metrics, such as seasonal/historical usage/valuation averages (supplied by the utility). For those areas where time-of-day rates apply, the ECOSHARE credits may be segregated into time-of-day ECOSHARE credits with independent valuations (i.e., prime-time ECOSHARE credits and off-hour ECOSHARE credits).
   Ongoing ECOSHARE credit valuation may be set based upon the ongoing calculated market value, which may be based upon metrics defined at the supplier level, or in the case of infrastructure-related resources, on the metrics defined specifically for the given resource.
   It is assumed all valuations may support “incentive” metrics to promote use of the system over straight usage billing.
   Trade/trade fee tracking.
Ability to trade in ECOSHARE credits as part of utility bill payment.
Support mail invoicing for membership fees as well as email alerts/invoices and both paper and electronic payment forms.
Possible future direct account billing for utility bills.
Fee transaction system
   Support purchase of ECOSHARE credits
   Support purchase of ad space
   Support purchase of online report, professional membership (future)
Marking of ECOSHARE credits as “consumed” when they are turned in for credit on bill payments.

Additional functionality, though not necessary to initiate the integrated credit exchange system, may include the following:
Usage-based discounts to subscribers for percentage reductions in historical usage rates.
Messaging.
Support messaging and messaging queues, account inboxes, and general management of messages (archive/move/delete/forward).
Optional email notifications for changing conditions (i.e., when ECOSHARE credits fall below or rise above user-specified levels, when specified user ECOSHARE credits are bid on, when a specified number of ECOSHARE credits become available at a specified value or based upon market or other parameters, etc.
Sending questions/messages to sellers/bidders. Sending to bidders is only allowed in response to questions.
Social networking.
Local and regional/utility news/events.
Support for social grouping (strategy/regional/interest/trading groups, etc).
Discussion forums for end users with a variety of topical categories.
Area for user to post information/experiences, Q&A.
Group information for users of particular utilities/suppliers.
Social networking system for community associations.
Ad generation/tracking.
System to fully automate or help automate capture and setup of new ads.
Support for single ads as well as ad groupings.
Rotation and placement strategies, both around the site and based upon time of day.
Automated scheduling for start/stop of ads/ad groups.
News events.
Help.
Documentation on using the system (in addition to context sensitive help embedded throughout the site).
Policies.
Site policies, copyright, legal information.
Troubleshooting/FAQ/support.
An area or areas where user can find information regarding “How-To's,” commonly encountered issues/questions, a knowledgebase, and a request for support form/support ticketing system as well as email and (optional) phone support contact information. Included may be support for reporting abuse and failure to meet conditions of purchase/sale. System administrators may have the ability to intercede as well as modify/commit/back out transactions and disable/re-enable user accounts.
Optional online chat (for “professional” membership level).

API's 200 may be implemented based upon best compatibility with industry standards. Multiple API technologies may need to be implemented.

The trading system 50 of the integrated credit exchange system may be implemented in one phase, or in multiple phases for efficiency of introduction.

Since many modifications, variations and changes in detail can be made to the described preferred embodiments of the invention, it is intended that all matters in the foregoing description and shown in the accompanying drawings be interpreted as illustrative, and not in a limiting sense. Thus, the scope of the invention should be determined by the appended claims and their legal equivalents.

I claim:

1. A credit exchange system for conservation of resources by consumers, comprising:
a credit allocation system configured to create ECOSHARE credits having a correspondence with units of said resource, configured to establish the number of said ECOSHARE credits to allot to each of said consumers, and configured to allocate said established number of said ECOSHARE credits to each of said consumers;
a trading system configured as an online market allowing said consumers to utilize said ECOSHARE credits in performing at least one of the following exchange activities: buy, sell, trade, save, and donate;
a consumer interface system configured to display information relating to said trading system.

2. The credit exchange system for conservation of resources by consumers, further comprising a measuring system configured to acquire usage measurements of said resource in at least near real time and configured to transmit data representing said usage measurements to said trading system.

3. The credit exchange system for conservation of resources by consumers, further comprising a geospatial monitoring system configured to provide information on supply of said resource.
